(19) United States
(12) Patent Application Publication
(10) Pub. No.: US 2021/0357517 A1
(43) Pub. Date: Nov. 18, 2021

(54) APPARATUSES AND METHODS FOR IMPROVED DATA PRIVACY

(71) Applicant: Wells Fargo Bank, N.A., San Francisco, CA (US)

(72) Inventors: Ramanathan RAMANATHAN, Bellevue, WA (US); Pierre ARBADJIAN, Matthews, NC (US); Andrew J. GARNER, IV, State Road, NC (US); Ramesh YARLAGADDA, Charlotte, NC (US); Abhijit RAO, Irvine, CA (US); Joon MAENG, Newcastle, WA (US)

(21) Appl. No.: 16/874,189

(22) Filed: May 14, 2020

(51) Int. Cl. G06F 21/60; G06F 21/62; G06F 21/57

(52) U.S. Cl. CPC G06F 21/604; G06F 21/577; G06F 21/6245

(57) ABSTRACT

Apparatuses, methods, and computer program products are provided for improved data privacy. An example method includes receiving a standard model where the standard model includes user data associated with a plurality of users, and the user data is associated with one or more privacy factors. The method also includes receiving a first privacy impact model that identifies a first privacy factor and analyzing the standard model with the first privacy impact model. The method also includes generating a first privacy impact score for the first privacy factor. The method may further include determining if the first privacy impact score satisfies a first privacy factor threshold. In an instance in which the first privacy impact score fails to satisfy the first privacy factor threshold, the method may generate a first violation notification or augment the standard model.

### TECHNOLOGICAL FIELD

Example embodiments of the present disclosure relate generally to data modeling and, more particularly, to user data privacy.

### BACKGROUND

Financial institutions and other entities often collect or otherwise have access to a large amount of user data. This user data may be utilized by these entities to generate models (e.g., machine learning models or otherwise) for providing products to their customers. These institutions, however, are also subject to a number of regulations that limit the factors that may be considered in identifying/selecting customers as well as the model's effect on customers in protected classes

### BRIEF SUMMARY

As described above, financial institutions and other entities may utilize a variety of models in the normal course of providing products to their customers. By way of example, a model may be created and used to identify or select customers for receiving a particular mortgage product, interest rate, retirement account, or the like. In order to generate these models, these entities may collect or otherwise access user data, and this user data may include various private information (e.g., age, gender, income, geographic location, ethnicity, etc.) associated with users. These institutions, however, are also subject to a number of regulations that limit the factors that may be considered in identifying/selecting customers as well as the model's effect on customers in protected classes. Furthermore, customers are becoming increasingly concerned over how their data is used (e.g., outside of their control), such as in generating these models.

To solve these issues and others, example implementations of embodiments of the present disclosure may utilize privacy impact models designed to identify vulnerable privacy factors associated with user data of a standard model (e.g., machine learning model) to prevent the dissemination of private user data. In operation, embodiments of the present disclosure may receive a standard model that includes user data associated with a plurality of users and this user data may include one or more privacy factors. A privacy impact model configured to identify a particular privacy factor may be used to analyze the standard model to generate a privacy impact score related to said privacy factor. In instances in which the privacy score fails to satisfy one or more privacy-related thresholds, embodiments of the present disclosure may generate a violation notification and/or augment the standard model. In this way, the inventors have identified that the advent of emerging computing technologies have created a new opportunity for solutions for improving data privacy which were historically unavailable. In doing so, such example implementations confront and solve at least two technical challenges: (1) they identify potential user privacy factor vulnerabilities, and (2) they dynamically adjust user data modeling to ensure data privacy related compliance.

As such, apparatuses, methods, and computer program products are provided for improved data privacy. With reference to an example method, the example method may include receiving, via a computing device, a standard model, wherein the standard model comprises user data associated with a plurality of users, and wherein the user data comprises one or more privacy factors. The method may also include receiving, via the computing device, a first privacy impact model, wherein the first privacy impact model is configured to identify a first privacy factor. The method may further include analyzing, via factor analysis circuitry of the computing device, the standard model with the first privacy impact model. The method may also include generating, via impact evaluation circuitry of the computing device, a first privacy impact score for the first privacy factor.

In some embodiments, the method may include determining, via the impact evaluation circuitry, if the first privacy impact score satisfies a first privacy factor threshold. In an instance in which the first privacy impact score fails to satisfy the first privacy factor threshold, the method may include generating, via communications circuitry of the computing device, a first violation notification. In other embodiments, in an instance in which the first privacy impact score fails to satisfy the first privacy factor threshold, the method may include augmenting, via the factor analysis circuitry, the standard model.

In some embodiments, the method may include iteratively analyzing the standard model, via the factor analysis circuitry, to determine a plurality of privacy impact scores for the first privacy factor. In such an embodiment, generating the first privacy impact score for the first privacy factor may further include averaging the plurality of privacy impact scores.

In some further embodiments, the method may include receiving, via the computing device, a second privacy impact model, wherein the second privacy impact model is configured to identify a second privacy factor. The method may also include analyzing, via the factor analysis circuitry, the standard model with the second privacy impact model, and generating, via the impact evaluation circuitry, a second privacy impact score for the second privacy factor.

In some still further embodiments, the method may include determining, via the impact evaluation circuitry, if the second privacy impact score satisfies a second privacy factor threshold. In an instance in which the second privacy impact score fails to satisfy the second privacy factor threshold, the method may include augmenting, via the factor analysis circuitry, the standard model.

In some still further embodiments, the method may include analyzing, via the factor analysis circuitry, the augmented standard model with the first privacy impact model, and generating, via the impact evaluation circuitry, an augmented first privacy impact score for the first privacy factor.

In some embodiments, the method also include analyzing, via data sensitivity circuitry of the computing device, the standard model and identifying, via the data sensitivity circuitry, user data comprising sensitive privacy factors. In such an embodiment, the method may further include augmenting, via the factor analysis circuitry, the standard model to remove the sensitive privacy factors from the standard model.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 illustrates a schematic block diagram of example circuitry that may perform various operations, in accordance with some example embodiments described herein.

FIG. 3 illustrates an example flowchart for improved data privacy including a first privacy impact model, in accordance with some example embodiments described herein.

FIG. 4 illustrates an example flowchart for privacy impact score determinations, in accordance with some example embodiments described herein.

FIG. 5 illustrates an example flowchart for improved data privacy including a second privacy impact model, in accordance with some example embodiments described herein.

FIG. 6 illustrates an example flowchart for data sensitivity determinations, in accordance with some example embodiments described herein.

### DETAILED DESCRIPTION

Some embodiments of the present disclosure will now be described more fully hereinafter with reference to the accompanying drawings, in which some, but not all embodiments of the disclosure are shown. Indeed, these embodiments may be embodied in many different forms and should not be construed as limited to the embodiments set forth herein; rather, these embodiments are provided so that this disclosure will satisfy applicable legal requirements. Like numbers refer to like elements throughout. As used herein, the description may refer to a privacy impact server as an example “apparatus.” However, elements of the apparatus described herein may be equally applicable to the claimed method and computer program product. Thus, use of any such terms should not be taken to limit the spirit and scope of embodiments of the present disclosure.

### DEFINITION OF TERMS

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used herein to mean “serving as an example, instance, or illustration.” Any implementation described herein as “example” is not necessarily to be construed as preferred or advantageous over other implementations.

As used herein, the terms “model,” “machine learning model,” and the like refer to mathematical models based upon training or sample data (e.g., user data as described hereafter) and configured to perform various tasks without explicit instructions. Said differently, a machine learning model may predict or infer tasks to be performed based upon training data, learning algorithms, exploratory data analytics, optimization, and/or the like. The present disclosure contemplates that any machine learning algorithm or training (e.g., supervised learning, unsupervised learning, reinforcement learning, self learning, feature learning, anomaly detection, association rules, etc.) and model (e.g., artificial neural networks, decision tress, support vector machines, regression analysis Bayesian networks, etc.) may be used in the embodiments described herein.

Furthermore, the term “standard model” may refer to a mathematical model that includes user data associated with a plurality of users and associated privacy factors. A “standard model” as described herein may be utilized for identifying and selecting users to, for example, receive one or more products of a financial institution. A “privacy impact model,” however, may refer to a mathematical model configured to or otherwise designed for a particular privacy factor. By way of example, a first privacy impact model may be configured to identify (e.g., predict, infer, etc.) age-related user data. As described hereafter, privacy impact models may be configured to analyze a standard model with respect to the particular privacy factor of the privacy impact model.

As used herein, the term “user data database” refers to a data structure or repository for storing user data, privacy factor data, and the like. Similarly, the “user data” of the user data database may refer to data generated by or associated with a plurality of users or user device. In some embodiments, the user data may include one or more privacy factors associated with the plurality of users. By way of example, the user data may include privacy factors regarding the race, gender, income, geographic location, employment, birthdate, social security number, etc. of various users. Although described herein with reference to example privacy factors (e.g., age, gender, and the like), the present disclosure contemplates that the user data and privacy factors may refer to any information associated with a user. The user data database may be accessible by one or more software applications of the privacy impact server 200.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

Having set forth a series of definitions called-upon throughout this application, an example system architecture and example apparatus is described below for implementing example embodiments and features of the present disclosure.

### Device Architecture and Example Apparatus

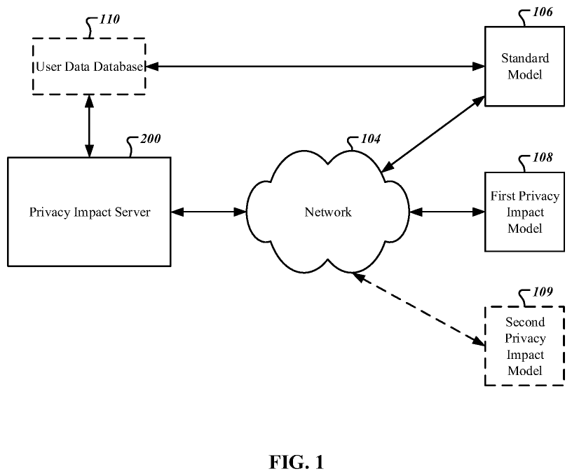

With reference to FIG. 1, an example system 100 is illustrated with an apparatus (e.g., a privacy impact server 200) communicably connected via a network 104 to a standard model 106, a first privacy impact model 108, and in some embodiments, a second privacy impact model 109. The example system 100 may also include a user data database 110 that may be hosted by the privacy impact server 200 or otherwise hosted by devices in communication with the privacy impact server 200. Although illustrated connected to the privacy impact server 200 via a network 104, the present disclosure contemplates that one or more of the standard model 106, the first privacy impact model 108, and/or the second privacy impact model 109 may be hosted and/or stored by the privacy impact server 200.

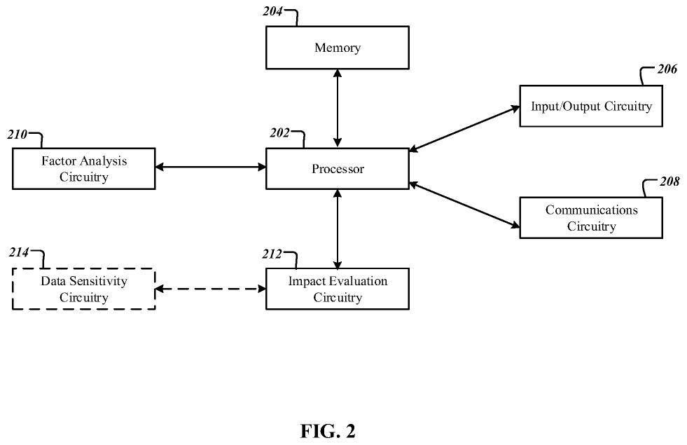

The privacy impact server 200 may include circuitry, networked processors, or the like configured to perform some or all of the apparatus-based (e.g., privacy impact server-based) processes described herein, and may be any suitable network server and/or other type of processing device. In this regard, privacy impact server 200 may be embodied by any of a variety of devices. For example, the privacy impact server 200 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, the privacy impact server 200 may be located remotely from the standard model 106, the first privacy impact model 108, the second privacy impact model 109, and/or user data database 110, although in other embodiments, the privacy impact server 200 may comprise the standard model 106, the first privacy impact model 108, the second privacy impact model 109, and/or the user data database 110. The privacy impact server 200 may, in some embodiments, comprise several servers or computing devices performing interconnected and/or distributed functions. Despite the many arrangements contemplated herein, the privacy impact server 200 is shown and described herein as a single computing device to avoid unnecessarily overcomplicating the disclosure.

The network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, the network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the network 104 may include a public network, such as the Internet, a private network, such as an intranet, or combinations thereof, and may utilize a variety of networking protocols now available or later developed including, but not limited to TCP/IP based networking protocols.

As described above, the standard model 106 may refer to a mathematical model that includes user data associated with a plurality of users and associated privacy factors. The standard model 106 may predict or infer tasks to be performed based upon training data (e.g., user data), learning algorithms, exploratory data analytics, optimization, and/or the like. The present disclosure contemplates that any machine learning algorithm or training (e.g., supervised learning, unsupervised learning, reinforcement learning, self learning, feature learning, anomaly detection, association rules, etc.) and model (e.g., artificial neural networks, decision tress, support vector machines, regression analysis Bayesian networks, etc.) may be used for the standard model 106. By way of example, the standard model 106 may include user data associated with a plurality of users and trained to identify and select customers for receiving a mortgage-related offer. Although described herein with reference to a mortgage-related offer, the present disclosure contemplates that the standard model 106 may be configured for any product or similar use based upon the intended application of the associated entity. As described above, the standard model 106 may be supported separately from the privacy impact server 200 (e.g., by a respective computing device) or may be supported by one or more other devices illustrated in FIG. 1.

As described above, the first privacy impact model 108 may refer to a mathematical model configured to or otherwise designed for a particular privacy factor (e.g., a first privacy factor). By way of example and as described hereafter, a first privacy impact model 108 may be configured to identify (e.g., predict, infer, etc.) age-related user data. As described hereafter, the first privacy impact model 108 may be configured to analyze the standard model 106 with respect to the first privacy factor of the first privacy impact model 108. Similarly, the second privacy impact model 109 may refer to a mathematical model configured to or otherwise designed for a particular privacy factor (e.g., a second privacy factor) different from the first privacy factor. By way of example and as described hereafter, a second privacy impact model may be configured to identify (e.g., predict, infer, etc.) gender-related user data. As described hereafter, the second privacy impact model 109 may be configured to analyze the standard model 106 with respect to the second privacy factor of the second privacy impact model 109. As described above, the first privacy impact model 108 and/or the second privacy impact model 109 may be supported separately from the privacy impact server 200 (e.g., by respective computing devices) or may be supported by one or more other devices illustrated in FIG. 1.

The user data database 110 may be stored by any suitable storage device configured to store some or all of the information described herein (e.g., memory 204 of the privacy impact server 200 or a separate memory system separate from the privacy impact server 200, such as one or more database systems, backend data servers, network databases, cloud storage devices, or the like provided by another device (e.g., online application or 3^{rd} party provider) or the standard or first privacy impact models 106, 108). The user data database 110 may comprise data received from the privacy impact server 200 (e.g., via a memory 204 and/or processor(s) 202), the standard model 106, the first privacy impact model 108, and/or the second privacy impact model 109 and the corresponding storage device may thus store this data.

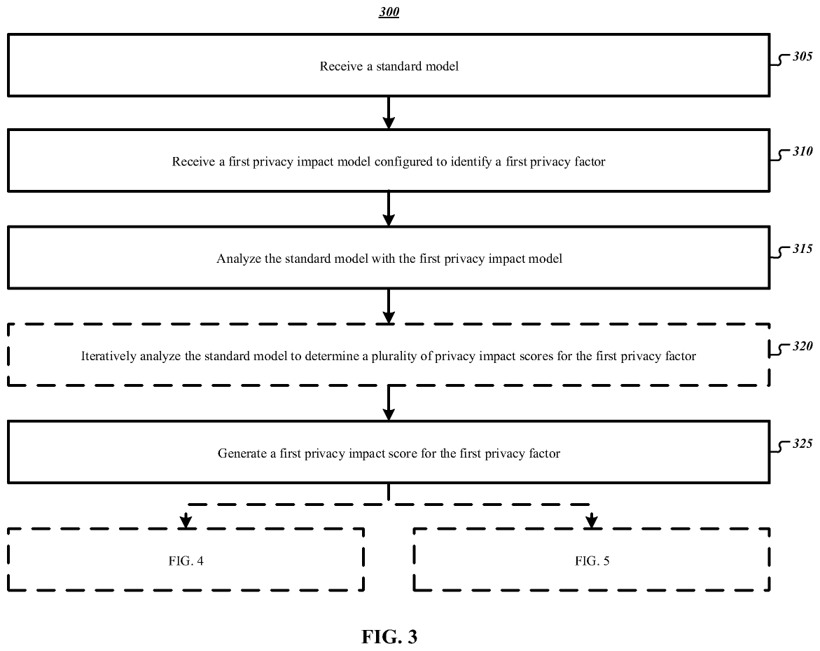

As illustrated in FIG. 2, the privacy impact server 200 may include a processor 202, a memory 204, communications circuitry 208, and input/output circuitry 206. Moreover, the privacy impact server 200 may include factor analysis circuitry 210, impact evaluation circuitry 212, and, in some embodiments, data sensitivity circuitry 214. The privacy impact server 200 may be configured to execute the operations described below in connection with FIGS. 3-6. Although components 202-214 are described in some cases using functional language, it should be understood that the particular implementations necessarily include the use of particular hardware. It should also be understood that certain of these components 202-214 may include similar or common hardware. For example, two sets of circuitry may both leverage use of the same processor 202, memory 204, communications circuitry 208, or the like to perform their associated functions, such that duplicate hardware is not required for each set of circuitry. The use of the term “circuitry” as used herein includes particular hardware configured to perform the functions associated with respective circuitry described herein. As described in the example above, in some embodiments, various elements or components of the circuitry of the privacy impact server 200 may be housed within the standard model 106, and/or the first privacy impact model 108. It will be understood in this regard that some of the components described in connection with the privacy impact server 200 may be housed within one of these devices (e.g., devices supporting the standard model 106 and/or first privacy impact model 108), while other components are housed within another of these devices, or by yet another device not expressly illustrated in FIG. 1.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the privacy impact server 200 may provide or supplement the functionality of particular circuitry.

In some embodiments, the processor 202 (and/or co-processor or any other processing circuitry assisting or otherwise associated with the processor) may be in communication with the memory 204 via a bus for passing information among components of the privacy impact server 200. The memory 204 may be non-transitory and may include, for example, one or more volatile and/or non-volatile memories. In other words, for example, the memory may be an electronic storage device (e.g., a non-transitory computer readable storage medium). The memory 204 may be configured to store information, data, content, applications, instructions, or the like, for enabling the privacy impact server 200 to carry out various functions in accordance with example embodiments of the present disclosure.

The processor 202 may be embodied in a number of different ways and may, for example, include one or more processing devices configured to perform independently. Additionally, or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the privacy impact server, and/or remote or “cloud” processors.

In an example embodiment, the processor 202 may be configured to execute instructions stored in the memory 204 or otherwise accessible to the processor 202. Alternatively, or additionally, the processor 202 may be configured to execute hard-coded functionality. As such, whether configured by hardware or by a combination of hardware with software, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

The privacy impact server 200 further includes input/output circuitry 206 that may, in turn, be in communication with processor 202 to provide output to a user and to receive input from a user, user device, or another source. In this regard, the input/output circuitry 206 may comprise a display that may be manipulated by a mobile application. In some embodiments, the input/output circuitry 206 may also include additional functionality such as a keyboard, a mouse, a joystick, a touch screen, touch areas, soft keys, a microphone, a speaker, or other input/output mechanisms. The processor 202 and/or user interface circuitry comprising the processor 202 may be configured to control one or more functions of a display through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the privacy impact server 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the privacy impact server 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

The factor analysis circuitry 210 includes hardware components designed to analyze the standard model with the first privacy impact model. The factor analysis circuitry 210 may further include hardware components for augmenting the standard model 106 in response to the operations described hereafter. The factor analysis circuitry 210 may utilize processing circuitry, such as the processor 202, to perform its corresponding operations, and may utilize memory 204 to store collected information.

The impact evaluation circuitry 212 includes hardware components designed generate a first privacy impact score (or second privacy impact score) for the first privacy factor (and/or the second privacy factor). The impact evaluation circuitry 212 may also be configured to determine if the first privacy impact score satisfies a first privacy factor threshold. Similarly, the impact evaluation circuitry 212 may also be configured to determine if the second privacy impact score satisfies a second privacy factor threshold. The impact evaluation circuitry 212 may utilize processing circuitry, such as the processor 202, to perform its corresponding operations, and may utilize memory 204 to store collected information.

The data sensitivity circuitry 214 includes hardware components designed to analyze the standard model 106 to determine user data comprising sensitive privacy factors. By way of example, the user data of the standard model 106 may, in some embodiments, be trained with user data that is particularly identifiable or sensitive. Said differently, the inclusion of such sensitive data (e.g., sensitive privacy factors) may immediately indicate the user associated with the data as described hereafter. The data sensitivity circuitry 214 may utilize processing circuitry, such as the processor 202, to perform its corresponding operations, and may utilize memory 204 to store collected information.

It should also be appreciated that, in some embodiments, the factor analysis circuitry 210, impact evaluation circuitry 212, and/or data sensitivity circuitry 214 may include a separate processor, specially configured field programmable gate array (FPGA), or application specific interface circuit (ASIC) to perform its corresponding functions.

In addition, computer program instructions and/or other type of code may be loaded onto a computer, processor, or other programmable privacy impact server's circuitry to produce a machine, such that the computer, processor other programmable circuitry that execute the code on the machine create the means for implementing the various functions, including those described in connection with the components of privacy impact server 200.

As described above and as will be appreciated based on this disclosure, embodiments of the present disclosure may be configured as systems, methods, mobile devices, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

### Example Operations for Improved Data Privacy

FIG. 3 illustrates a flowchart containing a series of operations for improved data privacy. The operations illustrated in FIG. 3 may, for example, be performed by, with the assistance of, and/or under the control of an apparatus (e.g., privacy impact server 200), as described above. In this regard, performance of the operations may invoke one or more of processor 202, memory 204, input/output circuitry 206, communications circuitry 208, factor analysis circuitry 210, impact evaluation circuitry 212, and/or data sensitivity circuitry 214.

As shown in operation 305, the apparatus (e.g., privacy impact server 200) includes means, such as input/output circuitry 206, communications circuitry 208, or the like, for receiving a standard model 106. As described above, the standard model 106 may include user data associated with a plurality of users. By way of example, the standard model 106 may be trained by user data associated with a plurality of users, for example, of a financial institution. The user data for the plurality of users may also include one or more privacy factors (e.g., age, ethnicity, gender, geographic location, employment, or the like). Although described herein with reference to the privacy impact server 200 receiving the standard model 106, over the network 104 or the like, the present disclosure contemplates that, in some embodiments, the privacy impact server 200 may be configured to generate or otherwise create the standard model 106.

The standard model 106 may be configured to identify and/or select, for example, customers of a financial institution for a particular product. By way of example, the standard model 106 may be generated by user data of a plurality of users (e.g., customers of the financial institution) and may include a plurality of privacy factors (e.g., age, ethnicity, geographic location, employment, or other private user data). The standard model 106 may be trained by this user data to identify, for example, customers to receive a mortgage related product. As described above, however, users (e.g., customers of the financial institution) may be wary or otherwise concerned with the use of their private data (e.g., user data having one or more privacy factors). Said differently, a user may be concerned that his or her age, gender, ethnicity, employment, geographic location, or the like is identifiable due to the use of his or her data in training the standard model 106. As such, the operations described hereafter with respect to the first privacy impact model 108 may be configured to identify potential user data privacy concerns with the standard model 106.

Thereafter, as shown in operation 310, the apparatus (e.g., privacy impact server 200) includes means, such as input/output circuitry 206, communication circuitry 208, or the like, for receiving a first privacy impact model 108. As described above, the first privacy impact model 108 may refer to a mathematical model configured to or otherwise designed for a particular privacy factor (e.g., a first privacy factor). By way of example, a first privacy impact model may be configured to identify (e.g., predict, infer, etc.) age-related user data. As described hereafter with reference to operation 315, the first privacy impact model 108 may be configured to analyze the standard model 106 with respect to the first privacy factor of the first privacy impact model 108. Although described herein with reference to the privacy impact server 200 receiving the first privacy impact model 108, over the network 104 or the like, the present disclosure contemplates that, in some embodiments, the privacy impact server 200 may be configured to generate or otherwise create the first privacy impact model 108. As described hereafter, the first privacy impact model 108 may be configured to predict or infer information related to the first privacy factor (e.g., age) based upon other adjacent (e.g., non-age-related user data).

Thereafter, as shown in operation 315, the apparatus (e.g., privacy impact server 200) includes means, such as processor 202, factor analysis circuitry 210, or the like, for analyzing the standard model 106 with the first privacy impact model 108. As described above, the first privacy impact model 108 may be configured to predict, identify, infer, determine, or the like user data related to the first privacy factor (e.g., age). By way of example, the standard model 106 may include user data having privacy factors related to income level, employment, ethnicity, retirement accounts, and the like, but may not explicitly include user age data. The first privacy impact model 108 may, however, analyze the user data used by the standard model 106 for a particular user (e.g., iteratively for each user in the plurality) and attempt to predict the age of the respective user based upon this remaining or adjacent user data. By way of further example, the standard model 106 may include data for a particular user that includes the value of the user's retirement account, the user's current income, and details regarding the user's employment. Based upon this information (e.g., a larger retirement account may indicate older age, a longer employment history may indicate older age, etc.), the first privacy impact model 108 may infer the age of the particular user of the standard model 106. The first privacy impact model 108 may analyze the user data of the standard model 106 for the plurality of users and attempt to predict or infer the age of each user from amongst the plurality of users.

In some embodiments, as shown in operation 320, the apparatus (e.g., privacy impact server 200) includes means, such as processor 202, factor analysis circuitry 210, or the like, for iteratively analyzing the standard model 106 to determine a plurality of privacy impact scores for the first privacy factor. Said differently, the first privacy impact model 108 may, in some embodiments, attempt to predict or infer the age of each user from amongst the plurality of users several times (e.g., any sufficient number of iterations based upon the intended application) such that each iteration of the analysis at operations 315, 320 includes a respective privacy impact score as described hereafter. In doing so, the privacy impact server 200 may operate to remove variability (e.g., outliers, false positives, etc.) associate with small sample sizes (e.g., a single inference analysis).

Thereafter, as shown in operation 325, the apparatus (e.g., privacy impact server 200) includes means, such as processor 202, impact evaluation circuitry 212, or the like, for a generating a first privacy impact score for the first privacy factor. In response to the analysis at operation 315, the privacy impact server 200 may generate a privacy impact score based upon the inferences or predictions of the first privacy impact model 108 with respect to the first privacy factor of the standard model 106. By way of continued example, the standard model 106 may include, for example, user data associated with one thousand (e.g., 1,000) users. At operation 315, the first privacy impact model 108 may, for example, correctly infer the age of one hundred (e.g., 100) users from amongst the example one thousand (e.g., 1,000) users. In such an example, the first privacy impact score may be 0.1 (e.g., a 10% correct inference rate) and may indicate a low user data privacy impact with regard to the first privacy factor (e.g., age). In other embodiments, the first privacy impact model 108 may, for example, correctly infer the age of seven hundred (e.g., 700) users from amongst the example one thousand (e.g., 1,000) users. In such an example, the first privacy impact score may be 0.7 (e.g., a 70% correct inference rate) and may indicate a high user data privacy impact with regard to the first privacy factor (e.g., age).

In some embodiments, as described above with reference to operation 320, the first privacy impact model 108 may iteratively analyze the standard model to determine a plurality of privacy impact scores for the first privacy factor. Said differently, the first privacy impact model 108 may, in some embodiments, attempt to predict or infer the age of each user from amongst the plurality of users several times (e.g., any sufficient number of iterations based upon the intended application) such that each iteration of the analysis at operations 315, 320 includes a respective privacy impact score as described hereafter. In doing so, the first privacy impact model 108 may generate a plurality of privacy impact score associated with respective iterations. For example, a first iteration may result in a privacy impact score of 0.2 (e.g., a 20% correct inference rate), a second iteration may result in a privacy impact score of 0.25 (e.g., a 25% correct inference rate), and a third iteration may result in a privacy impact score of 0.15 (e.g., a 15% correct inference rate). In such an embodiment, the privacy impact server 200 may average the plurality of privacy impact scores such that the first privacy impact score is an average of the respective plurality of privacy impact scores (e.g., 0.20 or a 20% correct inference rate).

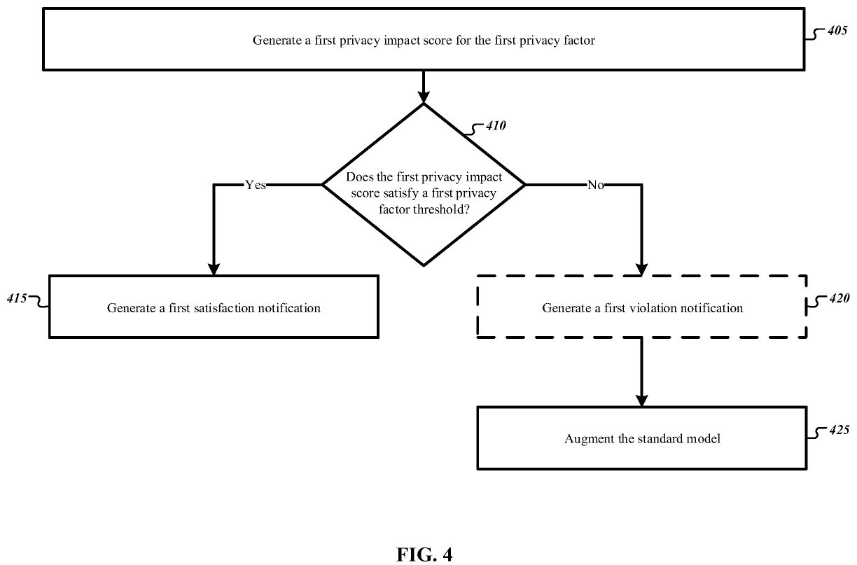

Turning next to FIG. 4, a flowchart is shown for privacy impact score determinations. The operations illustrated in FIG. 4 may, for example, be performed by, with the assistance of, and/or under the control of an apparatus (e.g., privacy impact server 200), as described above. In this regard, performance of the operations may invoke one or more of processor 202, memory 204, input/output circuitry 206, communications circuitry 208, factor analysis circuitry 210, impact evaluation circuitry 212, and/or data sensitivity circuitry 214.

As shown in operation 405, the apparatus (e.g., privacy impact server 200) includes means, such as input/output circuitry 206, communications circuitry 208, impact evaluation circuitry 212, or the like, for generating a first privacy impact score for the first privacy factor. As described above with reference to operation 325, the apparatus may generate a privacy impact score based upon the inferences or predictions of the first privacy impact model 108 with respect to the first privacy factor of the standard model 106.

As shown in operation 410, the apparatus (e.g., privacy impact server 200) includes means, such as input/output circuitry 206, communications circuitry 208, impact evaluation circuitry 212, or the like, for determining if the first privacy impact score satisfies a first privacy factor threshold. By way of example, the privacy impact server 200 may include one or more privacy impact thresholds each of which is associated with a particular privacy factor. These privacy impact thresholds may, in some embodiments, be user inputted, controlled by applicable regulations, and/or independently determined by the privacy impact server 200. Furthermore, each of the privacy impact factor thresholds, may, in some embodiment be different from other privacy impact factor thresholds. Said differently, each privacy factor may be associated with a respective threshold value that may be indicative or otherwise related to the privacy required with that type of user data (e.g., the associated privacy factor). Furthermore, each privacy factor threshold may also be variable or otherwise dynamically adjusted based upon the intended application of the privacy impact server 200.

With continued reference to operation 410, the first privacy impact score may be compared with the first privacy factor threshold to determine if the first privacy impact score satisfies the first privacy factor threshold. By way of continued example, the first privacy factor threshold may be defined as 0.3 such that any first privacy impact score that exceeds the 0.3 first privacy factor threshold fails to satisfy the first privacy factor threshold. In an instance in which the first privacy impact score fails to exceed 0.3 (e.g., is less than 0.3), the privacy impact server may determine that the first privacy impact score satisfies the first privacy factor threshold at operation 410. In such an instance, the apparatus (e.g., privacy impact server 200) may include means, such as input/output circuitry 206, communications circuitry 208, or the like, for generating a first satisfaction notification at operation 415. In some embodiments, the first satisfaction notification at operation 415 may be presented to a user for review. In other embodiments, the first satisfaction notification at operation 415 may be logged, stored, or otherwise recorded by the privacy impact server 200. In an instance in which the first privacy impact score fails to satisfy the first privacy factor threshold, the apparatus (e.g., privacy impact server 200) may include means, such as input/output circuitry 206, communications circuitry 208, or the like, for generating a first violation notification at operation 420.

In an instance in which the first privacy impact score fails to satisfy the first privacy factor threshold, as shown in operation 425, the apparatus (e.g., privacy impact server 200) includes means, such as processor 202, the factor analysis circuitry 210, or the like, augmenting, the standard model 106. As described above, an instance in which the first privacy impact score fails to satisfy the first privacy factor threshold, may indicate that the potential impact to user data with respect to the first privacy factor is too high or otherwise unacceptable.

By way of continued example to a privacy factor associated with age, the first privacy impact model 108 may sufficiently infer, identify, predict, or otherwise determine the age of user data of the standard model 106 (e.g., exceeding the first privacy factor threshold) such that the age of the user data of the standard model 106 has a high risk of identifying user age. As such, the privacy impact server 200 may, at operation 425, operate to augment or modify the standard model 106 to compensate for this privacy risk. By way of example, the privacy impact server 200 may identify and remove user data from the standard model 106 that is indicative of a user's age. In some embodiments, the privacy impact server 200 may iteratively remove and/or replace user data and perform the operations of FIGS. 3-4 until the first privacy impact score satisfies the first privacy factor threshold.

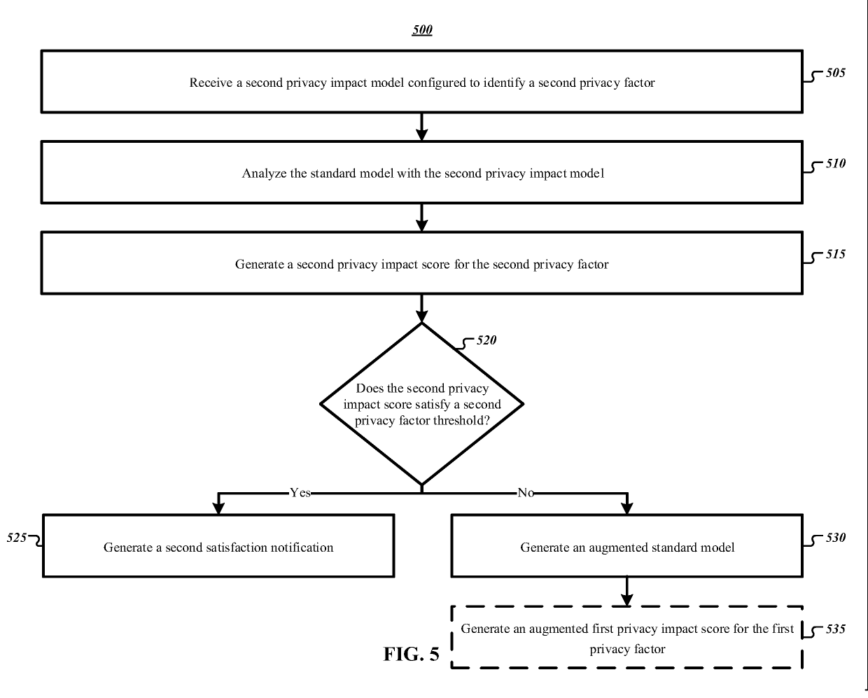

Turning next to FIG. 5, a flowchart is shown for improved data privacy including a second privacy impact model. The operations illustrated in FIG. 5 may, for example, be performed by, with the assistance of, and/or under the control of an apparatus (e.g., privacy impact server 200), as described above. In this regard, performance of the operations may invoke one or more of processor 202, memory 204, input/output circuitry 206, communications circuitry 208, factor analysis circuitry 210, impact evaluation circuitry 212, and/or data sensitivity circuitry 214.

As shown in operation 505, the apparatus (e.g., privacy impact server 200) includes means, such as input/output circuitry 206, communications circuitry 208, or the like, for receiving a second privacy impact model, wherein the second privacy impact model is configured to identify a second privacy factor. As described above, the privacy impact server 200 may utilize a plurality of privacy impact models, each configured to identify, infer, predict, or determine a separate privacy factor (e., race, gender, ethnicity, geographic location, or the like). As such, the privacy impact server 200, as illustrated in FIG. 5, may further determine any potential privacy impact associated with additional privacy factors via respective privacy impact models. Although described hereafter with reference to a second privacy impact model 109, the present disclosure contemplates that any number of privacy impact models may be employed by the privacy impact server 200.

As described above, the second privacy impact model 109 may refer to a mathematical model configured to or otherwise designed for a particular privacy factor (e.g., a second privacy factor). By way of example, a second privacy impact model 109 may be configured to identify (e.g., predict, infer, etc.) gender-related user data. As described hereafter with reference to operation 510, the second privacy impact model 109 may be configured to analyze the standard model 106 with respect to the second privacy factor of the second privacy impact model 109. Although described herein with reference to the privacy impact server 200 receiving the second privacy impact model 109, over the network 104 or the like, the present disclosure contemplates that, in some embodiments, the privacy impact server 200 may be configured to generate or otherwise create the second privacy impact model 109. As described hereafter, the second privacy impact model 109 may be configured to predict or infer information related to the second privacy factor (e.g., gender) based upon other adjacent (e.g., non-gender-related user data).

Thereafter, as shown in operation 510, the apparatus (e.g., privacy impact server 200) includes means, such as processor 202, factor analysis circuitry 210, or the like, for analyzing the standard model 106 with the second privacy impact model 109. As described above, the second privacy impact model 109 may be configured to predict, identify, infer, determine, or the like user data related to the second privacy factor (e.g., gender). By way of example, the standard model 106 may include user data having privacy factors related to income level, employment, ethnicity, retirement accounts, and the like, but may not explicitly include user gender data. The second privacy impact model 109 may, however, analyze the user data used by the standard model 106 for a particular user (e.g., iteratively for each user in the plurality) and attempt to predict the gender of the respective user based upon this remaining or adjacent user data. By way of further example, the standard model 106 may include data for a particular user that includes the user's prior account transactions, recurring membership charges, employment location, or the like. Based upon this information, the second privacy impact model 109 may infer the gender of the particular user of the standard model 106. The second privacy impact model 109 may analyze the user data of the standard model 106 for the plurality of users and attempt to predict or infer the gender of each user from amongst the plurality of users.

Thereafter, as shown in operation 515, the apparatus (e.g., privacy impact server 200) includes means, such as processor 202, impact evaluation circuitry 212, or the like, for a generating a second privacy impact score for the second privacy factor. In response to the analysis at operation 510, the privacy impact server 200 may generate a privacy impact score based upon the inferences or predictions of the second privacy impact model 109 with respect to the second privacy factor of the standard model 106. By way of continued example, the standard model 106 may include, for example, user data associated with one thousand (e.g., 1,000) users. At operation 510, the second privacy impact model 109 may, for example, correctly infer the gender of five hundred (e.g., 500) users from amongst the example one thousand (e.g., 1,000) users. In such an example, the second privacy impact score may be 0.5 (e.g., a 50% correct inference rate) and may indicate a low user data privacy impact with regard to the second privacy factor (e.g., gender). In other embodiments, the second privacy impact model 109 may, for example, correctly infer the gender of seven hundred (e.g., 850) users from amongst the example one thousand (e.g., 1,000) users. In such an example, the second privacy impact score may be 0.85 (e.g., an 85% correct inference rate) and may indicate a high user data privacy impact with regard to the second privacy factor (e.g., gender).

As is evident by the operations described regarding the first privacy impact model 108 of FIG. 3 and the second privacy impact model 109 of FIG. 5, the associated privacy factor threshold for each privacy impact score may vary based upon the nature of the privacy factor. Said differently, a privacy factor related to age includes a relatively large number of possibilities while a privacy factor related to gender includes a small number of possibilities. As such, the privacy factor thresholds described hereafter (e.g., the second privacy factor threshold) may appropriately reflect the number of potential options.

As shown in operation 520, the apparatus (e.g., privacy impact server 200) includes means, such as input/output circuitry 206, communications circuitry 208, impact evaluation circuitry 212, or the like, for determining if the second privacy impact score satisfies a second privacy factor threshold. As described above with reference to operation 410, the second privacy impact score may be compared with the second privacy factor threshold to determine if the second privacy impact score satisfies the second privacy factor threshold. By way of continued example, the second privacy factor threshold may be defined as 0.6 such that any second privacy impact score that exceeds the 0.6 second privacy factor threshold fails to satisfy the second privacy factor threshold. In an instance in which the second privacy impact score fails to exceed 0.6 (e.g., is less than 0.6), the privacy impact server 200 may determine that the second privacy impact score satisfies the second privacy factor threshold at operation 520. In such an instance, the apparatus (e.g., privacy impact server 200) may include means, such as input/output circuitry 206, communications circuitry 208, or the like, for generating a second satisfaction notification at operation 525. In some embodiments, the second satisfaction notification at operation 525 may be presented to a user for review. In other embodiments, the second satisfaction notification at operation 525 may be logged, stored, or otherwise recorded by the privacy impact server 200.

In an instance in which the second privacy impact score fails to satisfy the second privacy factor threshold, as shown in operation 520, the apparatus (e.g., privacy impact server 200) includes means, such as processor 202, the factor analysis circuitry 210, or the like, for augmenting the standard model to generate an augmented standard model at operation 530. As described above, an instance in which the second privacy impact score fails to satisfy the second privacy factor threshold, may indicate that the potential impact to user data with respect to the second privacy factor is too high or otherwise unacceptable.

By way of continued example to a second privacy factor associated with gender, the second privacy impact model 109 may sufficiently infer, identify, predict, or otherwise determine the gender of user data of the standard model 106 (e.g., exceeding the second privacy factor threshold) such that user data of the standard model 106 has a high risk of identifying user gender. As such, the privacy impact server 200 may, at operation 530, operate to augment or modify the standard model 106 to compensate for this privacy risk. By way of example, the privacy impact server 200 may identify and remove user data from the standard model 106 that is indicative of a user's gender. In some embodiments, the privacy impact server 200 may iteratively remove and/or replace user data and perform the operations of FIGS. 3 and 5 until the second privacy impact score satisfies the second privacy factor threshold.

In some embodiments, as shown in operation 535, the apparatus (e.g., privacy impact server 200) includes means, such as input/output circuitry 206, communications circuitry 208, impact evaluation circuitry 212, or the like, for generating an augmented first privacy impact score for the first privacy factor. As the operations of FIG. 5 are completed to accommodate for the privacy factor of the second privacy impact model 109, changes to the first privacy impact score may occur. In order to ensure that the augmented standard model (e.g., modified to address the second privacy factor threshold) continues to satisfy the first privacy factor threshold, the privacy impact server 200 may subsequently perform the operations of FIG. 3 as described above.

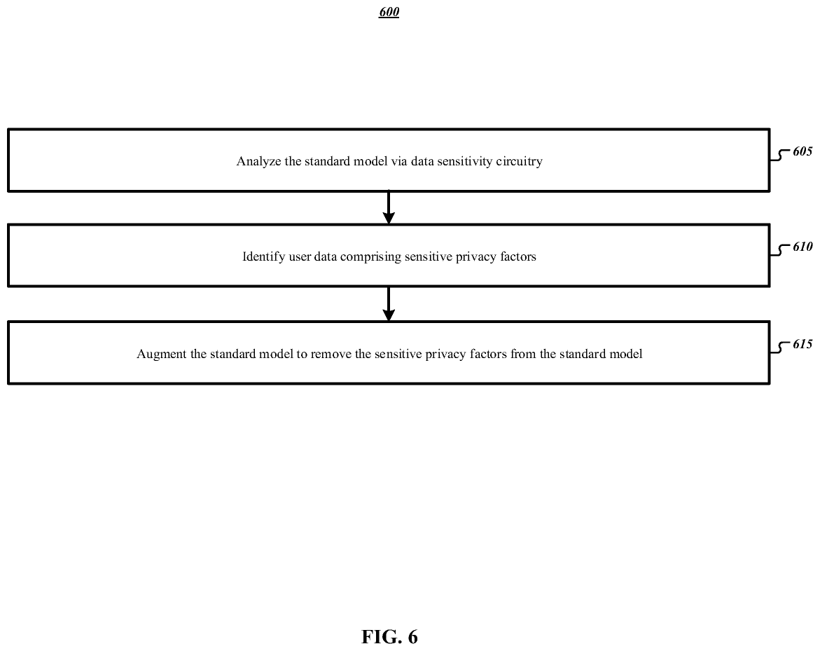

Turning next to FIG. 6, a flowchart is shown for data sensitivity determinations. The operations illustrated in FIG. 6 may, for example, be performed by, with the assistance of, and/or under the control of an apparatus (e.g., privacy impact server 200), as described above. In this regard, performance of the operations may invoke one or more of processor 202, memory 204, input/output circuitry 206, communications circuitry 208, factor analysis circuitry 210, impact evaluation circuitry 212, and/or data sensitivity circuitry 214.

As shown in operations 605 and 610, the apparatus (e.g., privacy impact server 200) includes means, such as input/output circuitry 206, communications circuitry 208, data sensitivity circuitry 214, or the like, for analyzing the standard model and identifying user data comprising sensitive privacy factors. In some instances, user data may include privacy factors or other user data that may independently pose a privacy concern. By way of example, user data related to a large bonus, merger deal, or the like may, on its own, identify a user associated with the bonus, merger, or the like. As such, the privacy impact server 200 may operate, via the data sensitivity circuitry 214, to identify user data of the standard model 106 having sensitive privacy factors. By way of example, the data sensitivity circuitry 214 may analyze each user data entry of the standard model 106 and identify any user data (e.g., outliers, identifiable information, or the like) that may pose a privacy related risk.

As shown in operation 615, the apparatus (e.g., privacy impact server 200) includes means, such as input/output circuitry 206, communications circuitry 208, factor analysis circuitry 210, data sensitivity circuitry 214, or the like, for augmenting the standard model 106 to remove the sensitive privacy factors from the standard model 106. As described above, the privacy impact server 200 may identify and remove user data from the standard model 106 that is poses an independent risk to privacy. In some embodiments, the privacy impact server 200 may iteratively remove and/or replace user data and perform the operations of FIG. 6 until the standard model 106 fails to include sensitive privacy factors

In doing so, the embodiments of the present disclosure solve these issues by utilizing privacy impact models designed to identify vulnerable privacy factors associated with user data of a standard model (e.g., machine learning model) to prevent the dissemination of private user data. In operation, embodiments of the present disclosure may receive a standard model that includes user data associated with a plurality of users and this user data may include one or more privacy factors. A privacy impact model configured to identify a particular privacy factor may be used to analyze the standard model to generate a privacy impact score related to said privacy factor. In instances in which the privacy score fails to satisfy one or more privacy-related thresholds, embodiments of the present disclosure may generate a violation notification and/or augment the standard model. In this way, the inventors have identified that the advent of emerging computing technologies have created a new opportunity for solutions for improving data privacy which were historically unavailable. In doing so, such example implementations confront and solve at least two technical challenges: (1) they identify potential user privacy factor vulnerabilities, and (2) they dynamically adjust user data modeling to ensure data privacy related compliance.

FIGS. 3-6 thus illustrate flowcharts describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of the privacy impact server 200 and executed by a processor 202 of the privacy impact server 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### CONCLUSION

Many modifications and other embodiments set forth herein will come to mind to one skilled in the art to which these embodiments pertain having the benefit of the teachings presented in the foregoing descriptions and the associated drawings. Therefore, it is to be understood that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for improved data privacy, the method comprising:
receiving, via a computing device, a standard model, wherein the standard model comprises user data associated with a plurality of users, and wherein the user data comprises one or more privacy factors;
receiving, via the computing device, a first privacy impact model, wherein the first privacy impact model is configured to identify a first privacy factor;
analyzing, via factor analysis circuitry of the computing device, the standard model with the first privacy impact model;
generating, via impact evaluation circuitry of the computing device, a first privacy impact score for the first privacy factor;
analyzing, via data sensitivity circuitry of the computing device, the standard model;
identifying, via the data sensitivity circuitry, user data comprising sensitive privacy factors; and
augmenting, via the factor analysis circuitry, the standard model to remove the sensitive privacy factors from the standard model.

2. The method according to claim 1, further comprising:
determining, via the impact evaluation circuitry, if the first privacy impact score satisfies a first privacy factor threshold; and
generating, via communications circuitry of the computing device, a first violation notification in an instance in which the first privacy impact score fails to satisfy the first privacy factor threshold.

3. The method according to claim 1, further comprising:
determining, via the impact evaluation circuitry, if the first privacy impact score satisfies a first privacy factor threshold; and
augmenting, via the factor analysis circuitry, the standard model in an instance in which the first privacy impact score fails to satisfy the first privacy factor threshold.

4. The method according to claim 1, wherein analyzing the standard model with the first privacy impact model further comprises iteratively analyzing the standard model, via the factor analysis circuitry, to determine a plurality of privacy impact scores for the first privacy factor.

5. The method according to claim 4, wherein generating the first privacy impact score for the first privacy factor further comprises averaging the plurality of privacy impact scores.

6. The method according to claim 1, further comprising:
receiving, via the computing device, a second privacy impact model, wherein the second privacy impact model is configured to identify a second privacy factor;
analyzing, via the factor analysis circuitry, the standard model with the second privacy impact model; and
generating, via the impact evaluation circuitry, a second privacy impact score for the second privacy factor.

7. The method according to claim 6, further comprising:
determining, via the impact evaluation circuitry, if the second privacy impact score satisfies a second privacy factor threshold; and
augmenting, via the factor analysis circuitry, the standard model in an instance in which the second privacy impact score fails to satisfy the second privacy factor threshold.

8. The method according to claim 7, further comprising:
analyzing, via the factor analysis circuitry, the augmented standard model with the first privacy impact model; and
generating, via the impact evaluation circuitry, an augmented first privacy impact score for the first privacy factor.

9. An apparatus for improved data privacy, the apparatus comprising:
communications circuitry configured to:
receive a standard model, wherein the standard model comprises user data associated with a plurality of users, and wherein the user data comprises one or more privacy factors; and
receive a first privacy impact model, wherein the first privacy impact model is configured to identify a first privacy factor;
factor analysis circuitry configured to analyze the standard model with the first privacy impact model;
impact evaluation circuitry configured to generate a first privacy impact score for the first privacy factor; and
data sensitivity circuitry configured to:
analyze the standard model; and
identify user data comprising sensitive privacy factors, wherein the factor analysis circuitry is further configured to augment the standard model to remove the sensitive privacy factors from the standard model.

10. The apparatus according to claim 9, wherein the impact evaluation circuitry is further configured to determine if the first privacy impact score satisfies a first privacy factor threshold and the communications circuitry is further configured to generate a first violation notification in an instance in which the first privacy impact score fails to satisfy the first privacy factor threshold.

11. The apparatus according to claim 9, wherein the impact evaluation circuitry is further configured to determine if the first privacy impact score satisfies a first privacy factor threshold and the factor analysis circuitry is further configured to augment the standard model in an instance in which the first privacy impact score fails to satisfy the first privacy factor threshold.

12. The apparatus according to claim 9, wherein the factor analysis circuitry is further configured to iteratively analyze the standard model to determine a plurality of privacy impact scores for the first privacy factor.

13. The apparatus according to claim 12, wherein the impact evaluation circuitry is further configured to generate the first privacy impact score for the first privacy factor by averaging the plurality of privacy impact scores.

14. The apparatus according to claim 9, wherein the communications circuitry is further configured to receive a second privacy impact model, wherein the second privacy impact model is configured to identify a second privacy factor; the factor analysis circuitry is further configured to analyze the standard model with the second privacy impact model; and the impact evaluation circuitry is further configured to generate a second privacy impact score for the second privacy factor.

15. The apparatus according to claim 14, wherein the impact evaluation circuitry is further configured to determine if the second privacy impact score satisfies a second privacy factor threshold; and the factor analysis circuitry is further configured to augment the standard model in an instance in which the second privacy impact score fails to satisfy the second privacy factor threshold.

16. The apparatus according to claim 15, wherein the factor analysis circuitry is further configured to analyze the augmented standard model with the first privacy impact model; and the impact evaluation circuitry is further configured to generate an augmented first privacy impact score for the first privacy factor.

17. A non-transitory computer-readable storage medium for using an apparatus for improved data privacy, the non-transitory computer-readable storage medium storing instructions that, when executed, cause the apparatus to:
receive a standard model, wherein the standard model comprises user data associated with a plurality of users, and wherein the user data comprises one or more privacy factors;
receive a first privacy impact model, wherein the first privacy impact model is configured to identify a first privacy factor;
analyze the standard model with the first privacy impact model;
generate a first privacy impact score for the first privacy factor analyze the standard model;
identify user data comprising sensitive privacy factors; and
augment the standard model to remove the sensitive privacy factors from the standard model.

18. The non-transitory computer-readable storage medium according to claim 17 storing instructions that, when executed, cause the apparatus to:
determine if the first privacy impact score satisfies a first privacy factor threshold; and
generate a first violation notification in an instance in which the first privacy impact score fails to satisfy the first privacy factor threshold.

19. The non-transitory computer-readable storage medium according to claim 17 storing instructions that, when executed, cause the apparatus to:
Determining if the first privacy impact score satisfies a first privacy factor threshold; and
Augmenting the standard model in an instance in which the first privacy impact score fails to satisfy the first privacy factor threshold.

20. The non-transitory computer-readable storage medium according to claim 17 storing instructions that, when executed, cause the apparatus to:
receive a second privacy impact model, wherein the second privacy impact model is configured to identify a second privacy factor;
analyze the standard model with the second privacy impact model; and
generate a second privacy impact score for the second privacy factor.
